(19) United States
(12) Patent Application Publication
(10) Pub. No.: US 2009/0070336 A1
(43) Pub. Date: Mar. 12, 2009

(54) METHOD AND SYSTEM FOR MANAGING TRANSMITTED REQUESTS

(75) Inventors: Volker Wiechers, Heidelberg (DE); Rainer Brendle, Palo Alto, CA (US); Horst Schnoerer, Angelbachtal (DE); Atul Sudhalkar, Sunnyvale, CA (US); Tibor Zakany, Budapest (HU)

Correspondence Address: BRAKE HUGHES BELLERMANN LLP, C/O INTELLEVATE, P.O. BOX 52050, MINNEAPOLIS, MN, 55402, US

(73) Assignee: SAP AG, Walldorf (DE)

(21) Appl. No.: 11/852,091

(22) Filed: Sep. 7, 2007

(51) Int. Cl. G06F 17/30

(52) U.S. Cl. 707/10; 707/E17.005

(57) ABSTRACT

A method and system are described that may receive a message including a copy of a request and a request identifier associated with the request from a requestor and may determine whether the request identifier is stored in a received item database. The request may be processed based on executing a web services request, a response may be generated indicating receipt of the copy of the request, the response and the request identifier may be stored in the received item database, and the response and a copy of the request identifier may be sent to the requester, when the determining indicates that the request identifier is not stored in the received item database; else, a previous response associated with the request identifier may be retrieved from the received item database, and the retrieved previous response and a copy of the request identifier may be sent to the requester.

### TECHNICAL FIELD

This description relates to techniques for managing transmitted requests and responses.

### BACKGROUND

The emergence of computer networks such as the Internet has provided many different techniques for various entities to communicate and exchange information. For example, web services may be used by clients and providers for exchanging information via interoperable machine to machine interaction over a network. For example, web services may include web application programming interfaces (APIs) that may be accessed over a network, such as the Internet, and executed on a remote system hosting the requested services.

For example, a World Wide Web Consortium (W3C) web service may encompass many different systems, and may, as an example, be used by clients and servers that communicate using eXtensible Markup Language (XML) messages in accordance with a Simple Object Access Protocol (SOAP) standard. Protocols such as web service (WS) Reliable Messaging have been under development for reliable messaging between two web services.

An example scenario may include a client or requester sending a request for processing of a web service to a provider, which may be located remotely from the client or requestor. If the client or requester does not receive a response or acknowledgment from the provider indicating receipt of the request, then the client or requester may not easily be able to determine whether the request was actually received and processed by the provider, or may have been lost due to a communication failure. For example, for a client or requestor and a provider using synchronous stateless web services to update Advanced Business Application Programming (ABAP) business objects, the client may not receive an acknowledgement due to communication failures. The client or requestor may not be able to distinguish whether the request failed or the response failed. Resending the same message (e.g., executing the web service with the same parameter) may then tend to generate duplicate records, as the provider may process the same request again if the client or requestor re-transmits the same request.

Thus, it may be desirable to provide techniques for managing requests from requestors, and responses to the requests, which minimize or eliminate multiple occurrences of processing of a single request from a requester.

### SUMMARY

According to one general aspect, a system includes a request manager including a receiving device configured to receive a message including a copy of a request and a request identifier associated with the request from a requester. The request manager further includes a received item database configured to store copies of request identifiers associated with requests, received from requesters by the receiving device. The request manager further includes an acknowledgement manager configured to generate a response message including the request identifier. The request manager further includes a duplicate request manager configured to determine whether the request identifier is stored in the received item database, in response to receipt of the message by the receiving device. Further, the request manager includes a response generator configured to generate a response indicating receipt of the copy of the request and the request identifier, and to request inclusion of the response in the response message by the acknowledgement manager, when the duplicate request manager indicates that the request identifier is not stored in the received item database. Additionally, the request manager includes a new request processor configured to process the request based on executing a web services request when the duplicate request manager indicates that the request identifier is not stored in the received item database and a new response storage manager configured to store the response and the request identifier in the received item database when the duplicate request manager indicates that the request identifier is not stored in the received item database. Further, the request manager includes a duplicate response storage manager configured to retrieve a previous response indicating receipt of a previous copy of the request from the received item database, and to request inclusion of the previous response in the response message by the acknowledgement manager, when the duplicate request manager indicates that the request identifier is stored in the received item database, and a transmitter configured to send the response message to the requester.

According to yet another aspect, a method includes receiving, at a receiving device, a message including a copy of a request and a request identifier associated with the request from a requester, and determining whether the request identifier is stored in a received item database, in response to receiving the message. The method further includes performing: processing the request based on executing a web services request, generating a response indicating receipt of the copy of the request and the request identifier, storing the response and the request identifier in the received item database, and sending the response and a copy of the request identifier to the requester, when the determining indicates that the request identifier is not stored in the received item database. The method further includes performing: retrieving a copy of a previous response associated with the request identifier from the received item database, and sending the retrieved response and a copy of the request identifier to the requester, when the determining indicates that the request identifier is stored in the received item database.

According to yet another aspect, a method includes obtaining a request based on executing a web services request for transmission to a receiver, generating a request identifier associated with the request, and sending a first copy of the request and request identifier to the receiver. The method includes determining whether a response is received indicating receipt of the first copy by the receiver. The method further includes sending a second copy of the request and request identifier to the receiver when it is determined that the response indicating receipt of the first copy is not received.

According to yet another aspect, a computer program product is tangibly embodied on a computer-readable medium and is configured to cause a data processing apparatus to receive, at a receiving device, a message including a copy of a request and a request identifier associated with the request from a requester. The computer program product is further configured to cause the data processing apparatus to determine whether the request identifier is stored in a received item database, in response to receiving the message. When the determining indicates that the request identifier is not stored in the received item database, the computer program product is further configured to cause the data processing apparatus to perform: process the request based on executing a web services request, generate a response indicating receipt of the copy of the request and the request identifier, store the response and the request identifier in the received item database, and send the response and a copy of the request identifier to the requester. When the determining indicates that the request identifier is stored in the received item database, the computer program product is further configured to cause the data processing apparatus to perform: retrieve a previous response associated with the request identifier from the received item database, and send the retrieved previous response and a copy of the request identifier to the requester.

According to yet another aspect, a computer program product is tangibly embodied on a computer-readable medium and is configured to obtain a request based on executing a web services request for transmission to a receiver. The computer program product is further configured to cause the data processing apparatus to generate a request identifier associated with the request, and send a first copy of the request and request identifier to the receiver. The computer program product is further configured to cause the data processing apparatus to determine whether a response is received indicating receipt of the first copy by the receiver. When it is determined that the response indicating receipt of the first copy is not received, the computer program product is further configured to cause the data processing apparatus to send a second copy of the request and request identifier to the receiver

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system for managing requests and responses.

FIG. 2 is a flowchart illustrating an operation of the system of FIG. 1.

FIG. 3 is a flowchart illustrating an operation of the system of FIG. 1.

FIGS. 4a-4c are timing diagrams that depict example request messages and response messages transmitted between a client and a provider according to an example embodiment.

FIG. 5 is a block diagram that depicts an example switching of data table storage associated with the system of FIG. 1 according to an example embodiment.

### DETAILED DESCRIPTION

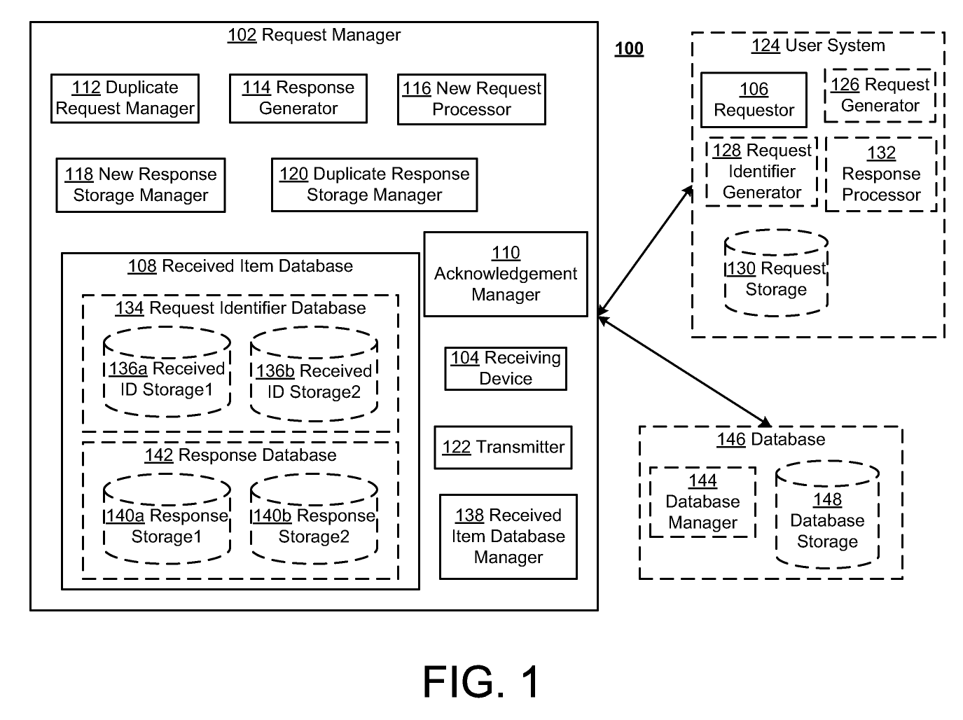

FIG. 1 is a block diagram of a system 100 for managing transmitted requests and responses. In the example of FIG. 1, a request manager 102 includes various processing engines that may be configured to manage transmitted requests and responses. According to an example embodiment, the request manager 102 may include a receiving device 104 configured to receive a message including a copy of a request and a request identifier associated with the request from a requestor 106. The request manager 102 may further include a received item database 108 configured to store copies of request identifiers associated with requests, received from requesters 106 by the receiving device 104. The request manager 102 may further include an acknowledgement manager 110 configured to generate a response message that may include the request identifier. The request manager 102 may further include a duplicate request manager 112 configured to determine whether the request identifier is stored in the received item database 108, in response to receipt of the message by the receiving device 104. Further, the request manager 102 may include a response generator 114 configured to generate a response indicating receipt of the copy of the request and the request identifier, and to request inclusion of the response in the response message by the acknowledgement manager 110, when the duplicate request manager 112 indicates that the request identifier is not stored in the received item database 108. Additionally, the request manager 102 may include a new request processor 116 configured to process the request based on executing a web services request when the duplicate request manager 112 indicates that the request identifier is not stored in the received item database 108.

According to an example, the request manager 102 may be included in a provider application, and may initiate a service call to handle incoming requests from users or clients.

The request manager 102 may further include a new response storage manager 118 configured to store the response and the request identifier in the received item database 108 when the duplicate request manager 112 indicates that the request identifier is not stored in the received item database 108. Further, the request manager 102 may include a duplicate response storage manager 120 configured to retrieve a previous response indicating receipt of a previous copy of the request from the received item database 108, and to request inclusion of the previous response in the response message by the acknowledgement manager 110, when the duplicate request manager 112 indicates that the request identifier is stored in the received item database 108, and a transmitter 122 configured to send the response message to the requestor 106.

According to an example embodiment, the requester 106 may be located at a location remote from the receiving device 104. For example, a user system 124 may include the requestor 106. For example, the requester 106 may include a client of a web service. For example, the requestor 106 may include a client of an online ordering system. According to an example embodiment, the request may be generated by a request generator 126, and the request identifier may be generated by a request identifier generator 128. For example, the request identifier may include a unique identifier associated with the request. For example, the request identifier may be generated by the request identifier generator 128 based on unique information associated with a processor included in the user system 124. According to an example embodiment, the request identifier may be generated by the requester 106 and may include a universally unique identifier associated with the request. For example, the universally unique identifier associated with the request may include a globally unique identifier (GUID) associated with the request.

According to an example embodiment, the user system 124 may include a request storage area 130 for storing requests that may be sent to the receiving device 104. According to an example embodiment, the user system 124 may include a response processor 132 for processing responses received from the transmitter 122.

According to an example embodiment, the received item database 108 may include a relational database located locally to the receiving device 104.

According to an example embodiment, the received item database 108 may include at least two data tables configured to store request identifiers. For example, the received item database 108 may include a request identifier database 134 that includes storage areas 136a and 136b, which may include data tables for storing request identifiers received from requesters 106.

According to an example embodiment, the new request processor 116 may be configured to process the request based on executing business logic associated with a web services request when the duplicate request manager 112 indicates that the request identifier is not stored in the received item database 108.

According to an example embodiment, the request manager 102 may further include a received item database manager 138 that may be configured to control switching of storage of request identifiers by the new response storage manager 118 between two or more request identifier data tables included in the received item database 108 based on at least one timestamp indicating a time of a most recent switching of the storage of the request identifiers. For example, the received item database manager 138 may be configured to control switching of storage of request identifiers by the new response storage manager 118 between data tables included in the storage areas 136a and 136b, based on one or more timestamps indicating a time of the most recent switching from one table to another. For example, after a predefined period of time, which may be configured by a user of the request manager 102, the table storing the older entries of the tables included in storage areas 136a and 136b may be configured for read-only access, and may be deleted after a predetermined lifetime of the request identifiers stored in the table to be deleted. The table storing the newer entries may be configured for read-write access until the received item database manager 138 initiates a switch to read-only access, followed by deletion of the table after a predetermined interval of read-only access.

According to an example embodiment, the received item database manager 138 may be configured to control switching of storage of responses by the new response storage manager 118 between two or more response data tables included in the received item database 108 based on at least one timestamp indicating a time of a most recent switching of the storage of the responses. For example, the received item database manager 138 may be configured to control switching of storage of responses by the new response storage manager 118 between data tables included in storage areas 140a and 140b, based on one or more timestamps indicating a time of the most recent switching from one table to another. The storage areas 140a and 140b may be included in a response database 142. For example, after a predefined period of time, which may be configured by a user of the request manager 102, the table storing the older entries of the tables included in storage areas 140a and 140b may be configured for read-only access, and may be deleted after a predetermined lifetime of the responses stored in the table to be deleted. The table storing the newer entries may be configured for read-write access until the received item database manager 138 initiates a switch to read-only access, followed by deletion of the table after a predetermined interval of read-only access.

According to an example embodiment, a lifetime of the request identifiers stored in the storage areas 136a and 136b may be longer than a lifetime of the responses stored in the storage areas 140a and 140b. For example, the received item database manager 138 may be configured to retain request identifiers for a longer period of time or other interval than responses.

According to an example embodiment, the request manager may manage information associated with the processing of the web services requests in association with a database manager 144 included in a database 146. Information associated with the processing of the web services requests may be stored in a database storage area 148, which may be located locally to the request manager 102, or remotely from the request manager 102.

According to an example scenario, a problem may arise during a synchronous call if a failure occurs. For example, if a connection failure occurs, a requester, or a client may not be able to differentiate whether a request from the client or a response from a receiver or provider has been lost. More particularly, the requestor or client may not be able to easily determine whether a call reached the service or not. According to an example embodiment, a receiver or provider may be able to recognize and handle a potential resend of the request from the requester or client and may ensure that requests are not processed multiple times, or, for example, that business documents are not stored multiple times.

According to an example embodiment, a common service layer may be provided for synchronous web services calls which provides techniques for the provider to identify the documents which have already been posted, and to retrieve the posted documents, instead of processing a received request a second time. According to an example embodiment, request identifiers or document identifiers may be maintained for a predetermined request identifier lifetime interval, and responses or documents may be maintained for a predetermined response lifetime interval for retrieval.

According to an example embodiment, the request identifiers or document identifiers and the responses or documents may be maintained in storage local to the receiver or provider.

According to an example embodiment, the requestor or client may generate a unique identifier associated with the request. For example, the requestor or client may generate a globally unique identifier (GUID) for association with each separate request. For example, the GUID may include a 128-bit integer (16 bytes) that may be used across all computers and networks for scenarios in which a unique identifier may be desirable. Such identifiers may have a very low probability of being duplicated.

According to an example embodiment, the requestor or client may begin using a service by assigning a unique ID to a particular request, and may include the generated ID in a field ID of the request message sent to the receiver or provider.

According to an example embodiment, application programming interfaces (APIs) may be used for processing requests from the requestor or client, and may be initialized based on the unique ID.

According to an example embodiment, when a provider application receives the request, the provider application may determine whether a document associated with the unique ID received with the request is already saved in a database local to the provider.

According to an example embodiment, if the document is posted and afterwards saved, the provider may retrieve the response document. According to an example embodiment, the provider may read the response from the local database, and may map response business documents as well, as an original business document structure may differ from an actual business document structure. According to an example embodiment, for security reasons, before passing back the response to the provider application, the service handling the received message may compare a username saved with the document (e.g., a username in runtime of the provider application at the save time of the document) against the actual username of the current requestor and the saved response may be passed back to the provider application only if the usernames are the same.

Thus, in order for the service handling the incoming requests to be able to differentiate between requesters or clients, a different username may be used for each requester or client that is different, and not, for example, a username defined in the service configuration of the provider application

According to an example embodiment, in order to read the response document a login-username of the provider service handling the incoming requests need not be changed in the time span from saving the response to retrieving the response.

According to an example embodiment, if the response is not saved by the provider service handling the incoming requests yet, the provider may hand over response documents for the provider service handling the incoming requests to store the response.

According to an example embodiment, deletion of the responses based on a lifetime of the responses may be performed by the provider indirectly in runtime. According to an example embodiment, a deletion technique may be periodically adjusted by a service administrator via a job switch planning program.

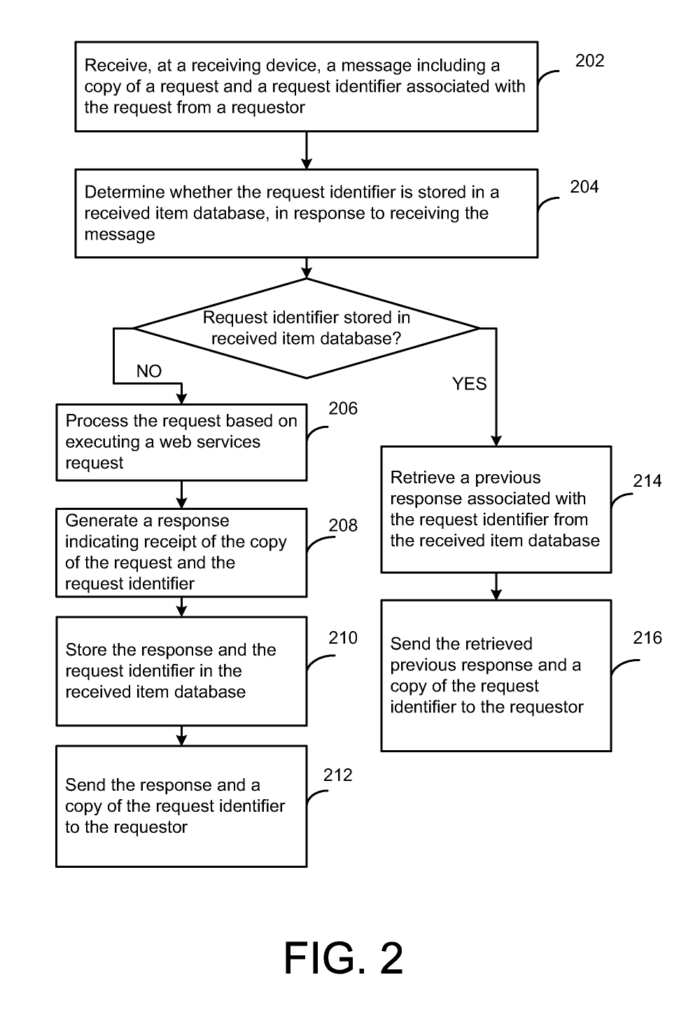

FIG. 2 is a flowchart illustrating an operation of the system of FIG. 1. According to an example embodiment, a method may include receiving, at a receiving device, a message including a copy of a request and a request identifier associated with the request from a requester (202). For example, the receiving device may include a provider receiving device, and the requestor 106 may include a client. For example, the client may be located remote from the receiving device 104, and communication between the requestor 106 and receiving device 104 may include stateless communication. For example, the communication may occur via the internet or other remote network connection subject to communication failure. For example, the requestor or client may invoke synchronous stateless web services to update Advanced Business Application Programming (ABAP) business objects with a provider.

The method may further include determining whether the request identifier is stored in a received item database, in response to receiving the message (204). For example, a provider may check whether the request identifier is stored in the received item database 108 discussed previously. For example, the duplicate request manager 112 discussed previously may determine whether the request identifier is stored in the received item database 108.

The method may further include performing: processing the request based on executing a web services request (206), generating a response indicating receipt of the copy of the request and the request identifier (208), storing the response and the request identifier in the received item database (210), and sending the response and a copy of the request identifier to the requestor (212), when the determining indicates that the request identifier is not stored in the received item database. For example, if the request identifier is not already stored in the received item database 108, then the request manager 102 may understand that the request has not been previously received and processed, and may thus process the request and send a response to the requester 106.

For example, a response or business document may be generated via the response generator 114 discussed previously. For example, the response or business document and the request identifier may be stored in the received item database 108 discussed previously. For example, the new request processor 116 discussed previously may process the request based on executing a web services request. For example, the new response storage manager 118 may store the newly generated response or business document, and the request identifier in the received item database 108. For example, the new request processor 116 may store the request identifier in the request identifier database 134 and the response in the response database 142 discussed previously.

For example, the acknowledgement manager 110 may generate the response message including the request identifier, and the transmitter 122 may send the response message to the requestor 106.

The method may further include performing: retrieving a copy of a previous response associated with the request identifier from the received item database (214), and sending the retrieved response and a copy of the request identifier to the requestor (216), when the determining indicates that the request identifier is stored in the received item database.

For example, when the duplicate request manager 112 determines that the request identifier is already stored in the received item database 108, in response to the receipt of the request, a copy of the previous response associated with the request identifier may be retrieved from the received item database 108 by the duplicate response storage manager 120 discussed previously. For example, the duplicate response storage manager 120 may request inclusion of the previous response in the response message generated by the acknowledgement manager 110. The transmitter 122 may then send the response message to the requestor 106. Thus, the request is not processed a second time, and the previously generated response is sent to the requester 106.

According to an example embodiment, the requester 106 may be located at a location remote from the receiving device 104.

According to an example embodiment, the received item database 108 may include a relational database located locally to the receiving device 104.

According to an example embodiment, the received item database 108 may include at least two data tables configured to store unique request identifiers. For example, the received item database 108 may include the request identifier storage areas 136a and 136b that may include separate data tables for storing the unique request identifiers. According to an example embodiment, the received item database 108 may include at least two data tables configured to store generated responses. For example, the received item database 108 may include the response storage areas 140a and 140b that may include separate data tables for storing the responses associated with the unique request identifiers.

According to an example embodiment, the request identifier may be generated by the requester 106 and may include a universally unique identifier associated with the request. For example, the request identifier may include a GUID.

According to an example embodiment, processing the request may include executing business logic associated with a web services request at the receiving device 104.

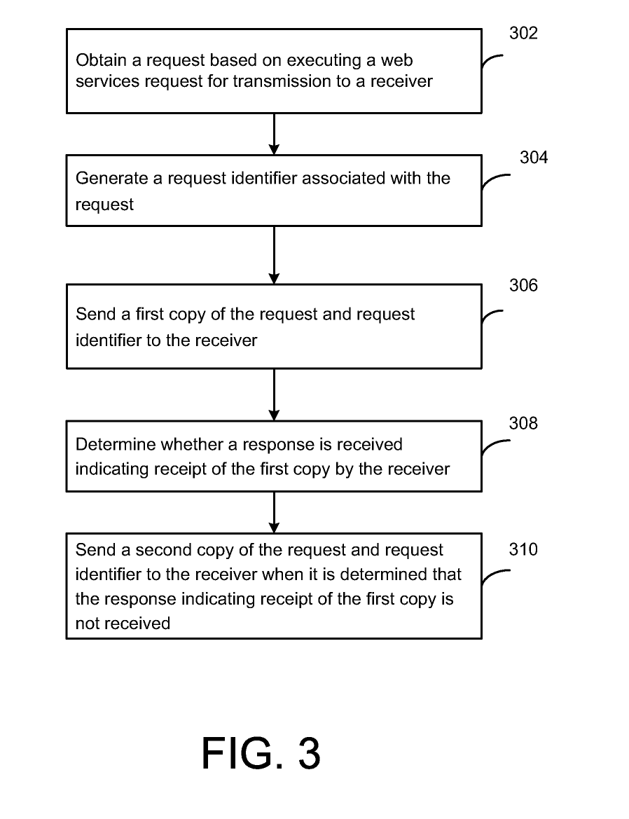

FIG. 3 is a flowchart illustrating an operation of the system of FIG. 1. According to an example embodiment, a method may include obtaining a request based on executing a web services request for transmission to a receiver (302). For example, the requestor 106 may obtain the request from the request generator 126 discussed previously.

The method may further include generating a request identifier associated with the request (304), and sending a first copy of the request and request identifier to the receiver (306). For example, the request identifier generator 128 discussed previously may generate the request identifier associated with the request, and may store the request in the request storage area 130. For example, the requester 106 may send the first copy of the request and request identifier to the receiving device 104.

The method may further include determining whether a response is received indicating receipt of the first copy by the receiver (308), and sending a second copy of the request and request identifier to the receiver when it is determined that the response indicating receipt of the first copy is not received (310). For example, the requestor 106 may determine that a predetermined period has passed, and that no response has been received, and may thus send the second copy of the request and request identifier to the receiving device 104.

According to an example embodiment, a copy of the obtained request may be stored in a request storage area. For example, a copy of the obtained request may be stored in the request storage area 130 as discussed previously. According to an example embodiment, the stored copy of the obtained request may be retrieved from the request storage area 130 when the determining step (at 308) determines that the response indicating receipt of the first copy is not received.

According to an example embodiment, the request identifier may include a universally unique identifier associated with the request. For example, the request identifier may include a GUID.

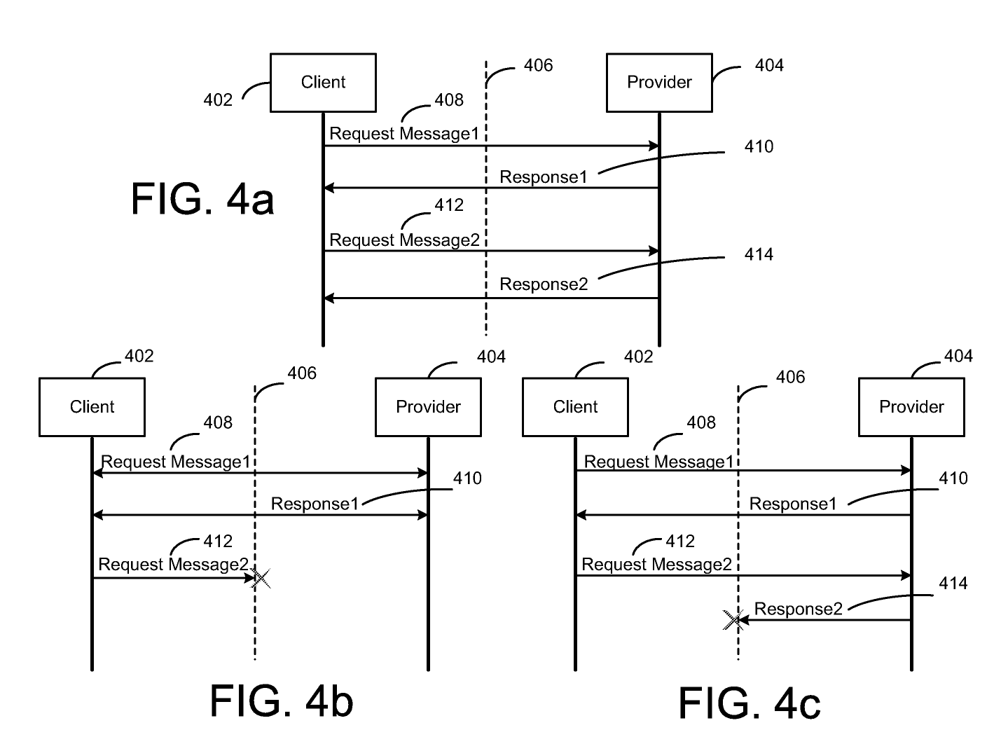

FIGS. 4a-4c are timing diagrams that depict example request messages and response messages transmitted between a client and a provider according to an example embodiment. As shown in FIG. 4, an example client 402 may communicate with a provider 404. For example, the client 402 may communicate with a provider 404 via a remote connection such as a wired or wireless connection, for example, via the Internet. The communication between the client 402 and the provider 404 may include communication through a boundary 406.

As shown in FIG. 4a, the example client 402 sends a request message1 408 to the example provider 404. The provider 404 receives the request message1 408 and responds by sending a response1 410 message to the client 402. For example, if the request message1 408 includes a web services request from the client 402, then the provider 404 may receive the request message1 408, process the web services request, and send the response1 410 message including an acknowledgement to the client 402 to inform the client 402 that the request message1 408 has been received and processed by the provider 404. Thus, the client 402 may understand that there may be no need to resend the web services request.

As shown in FIG. 4a, the example client 402 sends a request message2 412 to the example provider 404. The provider receives the request message2 412 and responds by sending a response2 414 message to the client 402. As shown in FIG. 4a, the messages sent by each party are received by the intended recipient. However, a connection failure may occur, for example, at the boundary 406, such that one of the messages may not be received by its intended recipient.

For example, FIG. 4b depicts a scenario in which the client 402 sends the request message2 412 to the example provider 404, but the provider 404 does not receive the request message2 412, for example, due to a connection failure in the communication medium used by the client 402 to communicate with the provider 404. As another example, FIG. 4c depicts a scenario in which the client 402 sends the request message2 412 to the example provider 404, and the provider receives the request message2 412 and responds by sending a response2 414 message to the client 402. However, in the example of FIG. 4c, the client 402 does not receive the response2 414 message, for example, due to a connection failure in the communication medium used by the provider 404 to communicate with the client 402. Since the client 402 does not receive the response2 414 message, the client 402 may be unable to determine whether the request message2 412 has been received and processed by the provider 404, i.e., the client 402 may be unable to determine whether the communication failure occurs before the provider 404 receives the request message2 412, or whether the communication failure occurs after the provider 404 receives the request message2 412, processes the request message2 412, and sends the response2 414 message toward the client 402.

It may be undesirable for the client 402 to re-transmit the request message2 412 to the provider 404 if the provider 404 merely processes each received request message, without regard to whether the request message may be a duplicate request sent by the client 402 due to lack of receipt of an acknowledgment message from the provider 404. Thus, according to an example embodiment, the client 402 may generate a unique request identifier associated with each request message, and may thus include the unique request identifier with the request message2 412. If the client 402 does not receive the response2 414 message acknowledging receipt of the request message2 412 by the provider 404 within a predetermined interval, the client 402 may re-send the request message2 412 to the provider 404, including the unique request identifier associated with the request message.

When the provider 404 receives the request message2 412, the provider 404 may then determine whether the request identifier received with the request message2 412 is already stored, for example, in the received item database 134 discussed previously.

If the received request identifier is not already stored in the received item database 134, then the provider 404 may understand that the provider 404 has not previously received and processed the request message2 412, and thus may understand that the provider 404 may need to process the newly received request message2 412. As discussed previously, the provider 404 may store a copy of the request identifier, for example, in the request identifier database 134, and may process the request message2 412. As discussed previously, the provider 404 may generate a response to be sent to the client 402 acknowledging receipt of the request message2 412, and the provider 404 may store a copy of the response, for example, in the response database 142 as discussed previously. The provider 404 may then send the response and the request identifier to the client 402 via the response2 414 message.

If the received request identifier is already stored in the received item database 134, then the provider 404 may understand that the provider 404 has previously received and processed the request message2 412, and thus may understand that the provider 404 may not need to process the newly received request message2 412. The provider 404 may also understand that the client 402 apparently did not receive the response2 414 message (e.g., as in FIG. 4c), and that the provider 404 may need to re-send the response2 414 message to the client 402, for example, as an acknowledgement of receipt by the provider 404 of the request message2 412. Thus, the provider 404 may retrieve the previously stored response, for example, from the response database 142 discussed previously, and may re-send the response2 414 message to the client 402, without processing the request a second time.

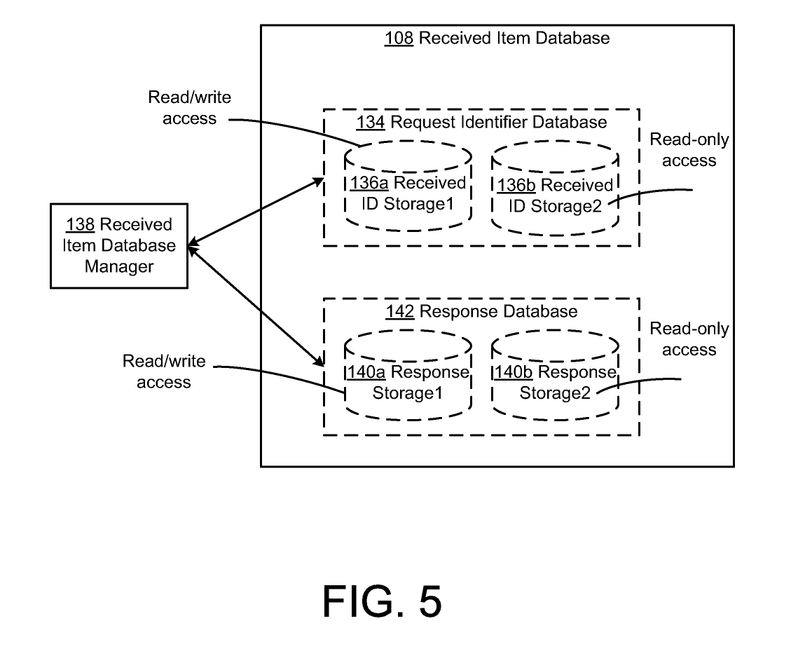

FIG. 5 is a block diagram that depicts an example switching of data table storage associated with the system of FIG. 1 according to an example embodiment. As discussed previously, the received item database manager 138 may be configured to control switching of storage of request identifiers by the new response storage manager 118 between two or more request identifier data tables included in the received item database 108 based on at least one timestamp indicating a time of a most recent switching of the storage of the request identifiers. The example of FIG. 5 depicts a current state of the received item database 106 wherein the request identifier storage area 136a is currently set to read/write access mode, and the request identifier storage area 136b is currently set to read-only access mode. Thus, for example, the new response storage manager 118 may only be allowed to write new request identifiers to the request identifier storage area 136a, while the duplicate request manager 112 and the duplicate response storage manager 120 may be allowed to read request identifiers from both the request identifier storage areas 136a and 136b.

Similarly, the example of FIG. 5 depicts a current state of the received item database 106 wherein the response storage area 140a is currently set to read/write access mode, and the response storage area 140b is currently set to read-only access mode. Thus, for example, the new response storage manager 118 may only be allowed to write new responses to the response storage area 140a, while the duplicate response storage manager 120 may be allowed to read previously stored requests from both the request storage areas 140a and 140b.

For example, the received item database manager 138 may be configured to control switching of various types of access by the new response storage manager 118 between data tables included in the storage areas 136a and 136b, based on one or more timestamps indicating a time of the most recent switching from one table to another. For example, after a predefined period of time, which may be configured by a user of the request manager 102, the table storing the older entries of the tables included in storage areas 136a and 136b may be configured for read-only access, and may then be deleted after a predetermined lifetime of the request identifiers stored in the table to be deleted. The table storing the newer entries may be configured for read-write access until the received item database manager 138 initiates a switch to read-only access, followed by deletion of the table after a predetermined interval of read-only access.

Similarly, after a predefined period of time, which may be configured by a user of the request manager 102, the table storing the older entries of the tables included in storage areas 140a and 140b may be configured for read-only access, and may be deleted after a predetermined lifetime of the responses stored in the table to be deleted. The table storing the newer entries may be configured for read-write access until the received item database manager 138 initiates a switch to read-only access, followed by deletion of the table after a predetermined interval of read-only access. Thus, the received item database 108 may only need to store responses to received requests and request identifiers for a predetermined time, which may be set by a user based on a user perception of a reasonable time for retention of the data tables in order to avoid duplicate processing of received requests.

According to an example embodiment, a lifetime of the request identifiers stored in the storage areas 136a and 136b may be longer than a lifetime of the responses stored in the storage areas 140a and 140b. For example, the received item database manager 138 may be configured to retain request identifiers for a longer period of time than responses.

According to an example embodiment, the data tables for storing the request identifiers in the storage areas 136a and 136b may be provided by separated software objects for each table, with an access class provided for each generated table.

According to an example embodiment, the data tables for storing the responses in the storage areas 140a and 140b may be provided by separated software objects for each table, with an access class provided for each generated table.

According to an example embodiment, the data tables for storing the responses may be separated from the data tables for storing the request identifiers, to simplify the deletion of the responses, and to provide separate lifetimes of data tables storing request identifiers from the data tables for storing requests.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall

What is claimed is:

1. A system comprising:
a request manager including:
a receiving device configured to receive a message including a copy of a request and a request identifier associated with the request from a requester;
a received item database configured to store copies of request identifiers associated with requests, received from requesters by the receiving device;
an acknowledgement manager configured to generate a response message including the request identifier;
a duplicate request manager configured to determine whether the request identifier is stored in the received item database, in response to receipt of the message by the receiving device;
a response generator configured to generate a response indicating receipt of the copy of the request and the request identifier, and to request inclusion of the response in the response message by the acknowledgement manager, when the duplicate request manager indicates that the request identifier is not stored in the received item database;
a new request processor configured to process the request based on executing a web services request when the duplicate request manager indicates that the request identifier is not stored in the received item database;
a new response storage manager configured to store the response and the request identifier in the received item database when the duplicate request manager indicates that the request identifier is not stored in the received item database;
a duplicate response storage manager configured to retrieve a previous response indicating receipt of a previous copy of the request from the received item database, and to request inclusion of the previous response in the response message by the acknowledgement manager, when the duplicate request manager indicates that the request identifier is stored in the received item database; and
a transmitter configured to send the response message to the requester.

2. The system of claim 1 wherein the requestor is located at a location remote from the receiving device.

3. The system of claim 1 wherein the received item database includes a relational database located locally to the receiving device.

4. The system of claim 1 wherein the received item database includes at least two data tables configured to store request identifiers.

5. The system of claim 1 wherein the request identifier is generated by the requestor and includes a universally unique identifier associated with the request.

6. The system of claim 1 wherein the new request processor is configured to process the request based on executing business logic associated with a web services request when the duplicate request manager indicates that the request identifier is not stored in the received item database.

7. The system of claim 1 further comprising:
a received item database manager configured to control switching of storage of request identifiers by the new response storage manager between two or more request identifier data tables included in the received item database based on at least one timestamp indicating a time of a most recent switching of the storage of the request identifiers.

8. The system of claim 1 further comprising:
a received item database manager configured to control switching of storage of responses by the new response storage manager between two or more response data tables included in the received item database based on at least one timestamp indicating a time of a most recent switching of the storage of the responses.

9. A method comprising:
receiving, at a receiving device, a message including a copy of a request and a request identifier associated with the request from a requester;
determining whether the request identifier is stored in a received item database, in response to receiving the message;
when the determining indicates that the request identifier is not stored in the received item database, performing:
processing the request based on executing a web services request,
generating a response indicating receipt of the copy of the request and the request identifier,
storing the response and the request identifier in the received item database, and
sending the response and a copy of the request identifier to the requester; and
when the determining indicates that the request identifier is stored in the received item database, performing:
retrieving a previous response associated with the request identifier from the received item database, and
sending the retrieved previous response and a copy of the request identifier to the requester.

10. The method of claim 9 wherein the requestor is located at a location remote from the receiving device.

11. The method of claim 9 wherein the received item database includes a relational database located locally to the receiving device.

12. The method of claim 9 wherein the received item database includes at least two data tables configured to store unique request identifiers.

13. The method of claim 9 wherein the received item database includes at least two data tables configured to store generated responses.

14. The method of claim 9 wherein the request identifier is generated by the requestor and includes a universally unique identifier associated with the request.

15. The method of claim 9 wherein the processing the request comprises:
executing business logic associated with a web services request at the receiving device.

16. A method comprising:
obtaining a request based on executing a web services request for transmission to a receiver;
generating a request identifier associated with the request;
sending a first copy of the request and request identifier to the receiver;
determining whether a response is received indicating receipt of the first copy by the receiver; and
sending a second copy of the request and request identifier to the receiver when it is determined that the response indicating receipt of the first copy is not received.

17. The method of claim 16 further comprising;
storing a copy of the obtained request in a request storage area; and
retrieving the stored copy of the obtained request from the request storage area when the determining determines that the response indicating receipt of the first copy is not received.

18. The method of claim 16 wherein the request identifier includes a universally unique identifier associated with the request.

19. A computer program product being tangibly embodied on a computer-readable medium and being configured to cause a data processing apparatus to:
receive, at a receiving device, a message including a copy of a request and a request identifier associated with the request from a requester;
determine whether the request identifier is stored in a received item database, in response to receiving the message;
when the determining indicates that the request identifier is not stored in the received item database, perform:
process the request based on executing a web services request,
generate a response indicating receipt of the copy of the request and the request identifier,
store the response and the request identifier in the received item database, and
send the response and a copy of the request identifier to the requestor; and
when the determining indicates that the request identifier is stored in the received item database, perform:
retrieve a previous response associated with the request identifier from the received item database, and
send the retrieved previous response and a copy of the request identifier to the requester.

20. The computer program product of claim 19 wherein the requestor is located at a location remote from the receiving device.

21. The computer program product of claim 19 wherein the received item database includes a relational database located locally to the receiving device.

22. The computer program product of claim 19 wherein the received item database includes at least two data tables configured to store unique request identifiers.

23. A computer program product being tangibly embodied on a computer-readable medium and being configured to cause a data processing apparatus to:
obtain a request based on executing a web services request for transmission to a receiver;
generate a request identifier associated with the request;
send a first copy of the request and request identifier to the receiver;
determine whether a response is received indicating receipt of the first copy by the receiver; and
send a second copy of the request and request identifier to the receiver when it is determined that the response indicating receipt of the first copy is not received.
